(19) United States
(12) Patent Application Publication
(10) Pub. No.: US 2024/0144411 A1
(43) Pub. Date: May 2, 2024

(54) MANAGEMENT APPARATUS

(71) Applicant: TOYOTA JIDOSHA KABUSHIKI KAISHA, Toyota-shi Aichi-ken (JP)

(72) Inventor: Hiroki TAKEISHI, Machida-shi Tokyo-to (JP)

(73) Assignee: TOYOTA JIDOSHA KABUSHIKI KAISHA, Toyota-shi Aichi-ken (JP)

(21) Appl. No.: 18/385,013

(22) Filed: Oct. 30, 2023

(30) Foreign Application Priority Data
Nov. 1, 2022 (JP) 2022-175762

(51) Int. Cl. G06Q 50/30; B60L 58/13; G06Q 30/0645

(52) U.S. Cl. CPC G06Q 50/30; B60L 58/13; G06Q 30/0645

(57) ABSTRACT

A management apparatus includes a controller configured to manage one or more vehicles to be rented to users in a car sharing service. The controller is configured to, in a case in which a vehicle returned by a user does not meet a return condition, notify the user that the return condition is not met when the user inputs an operation for return.

### CROSS-REFERENCE TO RELATED APPLICATION

This application claims priority to Japanese Patent Application No. 2022-175762, filed on Nov. 1, 2022, the entire contents of which are incorporated herein by reference.

### TECHNICAL FIELD

The present disclosure relates to a management apparatus that manages one or more vehicles used in a car sharing service.

### BACKGROUND

An apparatus that, based on images of a shared vehicle used for car sharing at the time of return, determines the degree of dirtiness of the shared vehicle and transmits the degree of dirtiness to a manager terminal is known (see, for example, Patent Literature (PTL) 1).

### CITATION LIST

### Patent Literature

PTL 1: JP 2021-047606 A

SUMMARY

The return of vehicles regardless of the states of the vehicles can cause problems for the next users who rent the vehicles.

It would be helpful to manage the states of vehicles to be rented to users in a car sharing service.

A management apparatus according to an embodiment of the present disclosure includes a controller configured to manage one or more vehicles to be rented to users in a car sharing service. The controller is configured to, in a case in which a vehicle returned by a user does not meet a return condition, notify the user that the return condition is not met when the user inputs an operation for return.

According to a management apparatus of an embodiment of the present disclosure, the states of vehicles to be rented to users in a car sharing service can be managed.

### BRIEF DESCRIPTION OF THE DRAWINGS

In the accompanying drawings:

FIG. 1 is a block diagram illustrating a configuration example of a management system according to an embodiment;

FIG. 2 is a flowchart illustrating a procedure example of a management method according to an embodiment; and

FIG. 3 is a flowchart illustrating a procedure example of the management method according to another embodiment.

### DETAILED DESCRIPTION

### Example Configuration of Management System 1

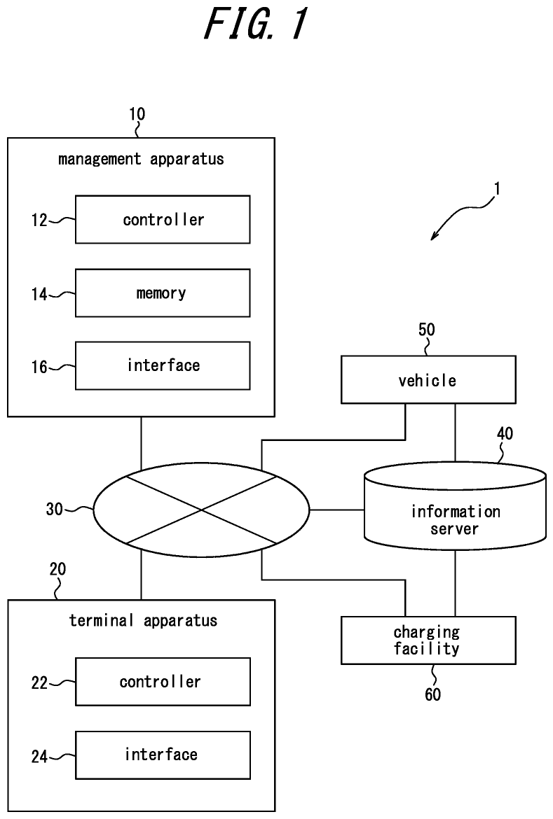

As illustrated in FIG. 1, a management system 1 according to an embodiment includes a management apparatus 10, a terminal apparatus 20, a vehicle 50, and a charging facility 60. The management system 1 provides a car sharing service in which the vehicle 50 is rented to users as a shared vehicle. The management apparatus 10 manages the states of the vehicle 50. The management apparatus 10 may manage the state of charge of a battery in a case in which the vehicle 50 is an electric vehicle. A specific configuration example of the management system 1 will be described below.

### Management Apparatus 10

The management apparatus 10 includes a controller 12, a memory 14, and an interface 16.

The controller 12 controls at least one component of the management apparatus 10. The controller 12 may be configured to include at least one processor. The “processor” is a general purpose processor, a dedicated processor specialized for specific processing, or the like in the present embodiment but not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The memory 14 may be configured to include a semiconductor memory, a magnetic memory, an optical memory, or the like, for example, but not limited to these. The memory 14 may function as, for example, a main memory, an auxiliary memory, or a cache memory. The memory 14 may be configured to include an electromagnetic storage medium, such as a magnetic disk. The memory 14 may be configured to include a non-transitory computer readable medium. The memory 14 stores any information or program to be used for operations of the management apparatus 10. For example, the memory 14 may store a system program, an application program, or the like. The memory 14 may be included in the controller 12.

Information, data, or the like is outputted from and inputted to the controller 12 through the interface 16. The interface 16 may include a communication module configured to be communicable to other devices, such as the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface 16 may be configured to be able to connect to a communication module.

The interface 16 may be configured with an input device for accepting input of information, data, or the like from a user. The input device may be configured to include, for example, a touch panel, a touch sensor, or a pointing device such as a mouse. The input device may be configured with a physical key. The input device may be configured to include an audio input device, such as a microphone. The interface 16 may be configured to be able to connect to an external input device. The interface 16 may be configured to be able to acquire, from the external input device, information or data inputted to the external input device.

The interface 16 may be configured to include an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescence (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information e.g. voice. The output device is not limited to the above examples and may include various other devices. The interface 16 may be configured to be able to connect to an external output device. The interface 16 may be configured to be able to output information or data to the external output device.

The management apparatus 10 may be configured to include a single server apparatus or a plurality of server apparatuses capable of communicating with each other. The management apparatus 10 may be realized as a cloud server.

### Terminal Apparatus 20

The terminal apparatus 20 is communicably connected to the management apparatus 10 and the like via the network 30. The terminal apparatus 20 includes a controller 22 and an interface 24.

The controller 22 may be configured with one or more processors or one or more dedicated circuits. The controller 22 may be configured to be identical or similar to the controller 12 of the management apparatus 10. The controller 22 may be configured to include a memory. The memory may be configured to be identical or similar to the memory 14 of the management apparatus 10.

The interface 24 may be configured to include an input device, an output device, or a communication device. The interface 24 may be configured to be identical or similar to the interface 16 of the management apparatus 10. The interface 24 may be wired or wirelessly communicably connected to the management apparatus 10 and the like. The interface 24 may include a display device. In a case in which the interface 24 includes the display device, the terminal apparatus 20 may function as a display apparatus.

The terminal apparatus 20 may be carried by a user, may be installed in the vehicle 50, or may be installed at a predetermined location including a return location for the vehicle 50, an installation location of the charging facility 60, or the like. The terminal apparatus 20 may be configured as a mobile terminal such as a smartphone or a tablet, or a Personal Computer (PC) such as a notebook PC or a tablet PC. The terminal apparatus 20 is not limited to the above examples and may include various devices. The number of terminal apparatuses 20 included in the management system 1 is not limited to one and may be two or more. The management system 1 does not have to include the terminal apparatus 20.

### Vehicle 50

The vehicle 50 may be an engine vehicle or an electric vehicle. The electric vehicle may include a Hybrid Electric Vehicle (HEV), a Plug-in Hybrid Electric Vehicle (PHEV), a Fuel Cell Electric Vehicle (FCEV), or a Battery Electric Vehicle (BEV). The number of vehicles 50 managed by the management system 1 is not limited to one, but may be two or more. The vehicle 50 may be configured to be operated by a driver or may be configured to travel by automated driving. The driver of the vehicle 50 may include the user himself/herself.

The vehicle 50 may include a communication device that is communicably connected to the management apparatus 10, the terminal apparatus 20, or the like. The vehicle 50 may further include a location information detector that acquires location information. The location information detector may be configured to include a receiver compliant with a satellite positioning system. The receiver compliant with the satellite positioning system may include, for example, a Global Positioning System (GPS) receiver. The location information detector may be configured to detect the location of the vehicle 50 based on a radio signal from a wireless communication device installed at the return location for the vehicle 50.

The vehicle 50 may include sensors that detect the states of various parts of the vehicle 50. The sensors may output, to the management apparatus 10 or the terminal apparatus 20, detection results of the states of the vehicle 50. The sensors may detect the states of windows opening or closing. The sensors may detect the states of doors opening or closing or the states of the doors locking. The sensors may detect the user's personal belongings left in the vehicle 50. The user's personal belongings may include luggage left on seats, a floor, or the like of the vehicle 50, cables or the like connected to in-vehicle devices, cards or the like inserted into the in-vehicle devices. The sensors may detect the lighting states of headlights, hazard lamps, interior lights, or the like of the vehicle 50. The sensors may detect whether the in-vehicle devices are turned on. The sensors may detect whether an engine is running in a case in which the vehicle 50 is an engine vehicle. The sensors may detect whether a main power source is turned on in a case in which the vehicle 50 is an electric vehicle. The sensors may detect charging and discharging current of the battery.

The vehicle 50 may include an Electronic Control Unit (ECU) that controls the communication device, the location information detector, or the sensors. The ECU may be configured to include one or more processors or one or more dedicated circuits.

### Charging Facility 60

The charging facility 60 is configured to charge the battery of the vehicle 50 in a case in which the vehicle 50 is an electric vehicle. The charging facility 60 may include a converter, an inverter, or the like to control current or voltage to be suppled to the battery of the vehicle 50. The charging facility 60 may include a processor or a dedicated circuit that controls battery charging. The charging facility 60 may include a power supply cable or a power supply connector that connects to the vehicle 50. The charging facility 60 may include a device configured to provide a non-contact power supply to the vehicle 50. The charging facility 60 may be connected to a power grid and charge the battery of the vehicle 50 with power supplied from the power grid. The charging facility 60 may include a power source, such as a battery or a generator, to charge the battery of the vehicle 50 with power supplied by the power source.

A power supply operation from the charging facility 60 to the vehicle 50 may be started by the user connecting the power supply cable or the power supply connector to the vehicle 50 when returning the vehicle 50. The charging facility 60 may be configured to automatically supply power to the vehicle 50 when the vehicle 50 is parked at a predetermined location. The charging facility 60 may include a sensor that detects the location of the vehicle 50 to check whether the vehicle 50 is parked at the predetermined location.

The charging facility 60 may include sensors that detect a power supply to the vehicle 50. For example, the sensors may detect a resistance value of a charging circuit when the vehicle 50 and the charging facility 60 are connected with the power supply cable or the power supply connector. The sensors may detect a current value flowing in the power supply cable or the power supply connector that connects to the vehicle 50. The sensors may include a camera that images the connection state of the power supply cable or the power supply connector to the vehicle 50. The sensors may include a contact sensor or the like that detects the connection of the power supply cable or the power supply connector to the vehicle 50. The charging facility 60 may include a communication device that is communicably connected to the management apparatus 10, the terminal apparatus 20, or the like. The communication device may output, to the management apparatus 10, the terminal apparatus 20, or the like, a detection result of the power supply to the vehicle 50.

The charging facility 60 may include the interface 16 of the management apparatus 10. The charging facility 60 may include the terminal apparatus 20. The charging facility 60 may include a display device or the like that provides information to the user. The charging facility 60 may display, on the interface 16, the terminal apparatus 20, the display device, or the like, information to instruct the user to perform the power supply operation.

### Information Server 40

The management system 1 according to the present embodiment may further include an information server 40. In some embodiments, the information server 40 my be omitted. The information server 40 may acquire information regarding the charging facility 60 or the vehicle 50, and store the information as a database or the like. The information server 40 may output the information regarding the charging facility 60 or the vehicle 50 to the management apparatus 10, the terminal apparatus 20, or the like. The information server 40 may include a processor or the like that functions as a controller. The information server 40 may include a memory or the like that functions as a memory. The information server 40 may include a communication device configured to be communicable with the management apparatus 10, the terminal apparatus 20, or the like. The information server 40 may be configured to include a single server apparatus or a plurality of server apparatuses capable of communicating with each other. The information server 40 may be realized as a cloud server.

### Operation Example of Management System 1

As described above, the management system 1 according to the present embodiment provides a car sharing service in which the vehicle 50 is rented to users as a shared vehicle. The management apparatus 10 manages the states of the vehicle 50. The states of the vehicle 50 include whether the vehicle 50 is in a rented state or in a returned state. The management apparatus 10 may manage reservations for the use of the vehicle 50.

The charging facility 60 is configured to charge the battery of the vehicle 50 in a case in which the vehicle 50 is an electric vehicle. The charging facility 60 is installed at the return location for the vehicle 50 and charges the battery of the vehicle 50 in the returned state of the vehicle 50.

The terminal apparatus 20 accepts operations for rent and return of the vehicle 50. The terminal apparatus 20 may accept operations to make a reservation for the use of the vehicle 50.

When a user returns the vehicle 50, the management system 1 according to the present embodiment accepts, at the management apparatus 10 or the terminal apparatus 20, an input of operations indicating that the user has completed the return of the vehicle 50. The input of the operations indicating that the user has completed the return of the vehicle 50 is also referred to as return input. The vehicle 50 to be returned is also referred to as returned vehicle. The controller 12 of the management apparatus 10 accepts the return input in a case in which the states of the vehicle 50 meets return conditions, and does not accept the return input in a case in which the states of the vehicle 50 does not meet the return conditions. In this way, the vehicle 50 is not returned unless the return conditions are met. As a result, the states of the returned vehicle are controlled without the need for a worker to inspect the returned vehicle. A specific operation example of the management system 1 will be described below.

### Operations at the Time of Return of Vehicle 50

In the case of returning the vehicle 50, the user parks the vehicle 50 at the return location. The user performs operations specified when returning the vehicle 50. The operations specified when returning the vehicle 50 are also referred to as return operations. The return operations may include parking the vehicle 50 at the correct return location. The return operations may include turning off the headlights, the hazard lamps, the interior lights, or the like. The return operations may include cleaning the interior or exterior of the vehicle 50. The return operations may include removing all the user's personal belongings from the vehicle 50. The return operations may include turning off the in-vehicle devices. The return operations may include turning off the engine in a case in which the vehicle 50 is an engine vehicle. The return operations may include turning off the main power source in a case in which the vehicle 50 is an electric vehicle. The return operations may include closing the windows of the vehicle 50 and locking the doors of the vehicle 50.

In the car sharing service provided by the management system 1 according to the present embodiment, when the electric vehicle is returned, the return operations include the power supply operation to charge the battery of the vehicle 50 by the charging facility 60 installed at the return location. The power supply operation may be performed by the user who returns the vehicle 50. The power supply operation may be started, for example, by the user connecting the cable of the charging facility 60 installed at the return location of the vehicle 50 to a plug of the vehicle 50. The power supply operation may be automatically started with a non-contact power supply by the user stopping the vehicle 50 at a predetermined location. The user may perform the power supply operation based on the instructions for the power supply operation provided at the return location. The instructions for the power supply operations may be displayed on the terminal apparatus 20 or the display device, or posted on a sign or the like at the return location.

### Return Input

In the case of having completed the return operations, the user inputs, on the interface 16 of the management apparatus 10 or the interface 24 of the terminal apparatus 20, an operation indicating that the return of the vehicle 50 has been completed. The return of the vehicle 50 from the user is completed when the controller 12 of the management apparatus 10 accepts the return input.

The controller 12 may confirm that the return operations have started, based on the location information on the vehicle 50 or the detection results of the various states of the vehicle 50. The controller 12 may check the progress of the return operations based on the detection results of the various states of the vehicle 50. When the user inputs the operations indicating that the return of the vehicle 50 has been completed, the controller 12 may determine, based on the detection results of the sensors, whether the vehicle 50 meets the return conditions. The controller 12 may accept the return input in a case in which the vehicle 50 meets the return conditions. The controller 12 may reject the return input in a case in which the vehicle 50 does not meet the return conditions. In a case in which the vehicle 50 does not meet the return conditions, the controller 12 may notify the user by displaying on the interface 16 of the management apparatus 10 or the interface 24 of the terminal apparatus 20 that the return conditions are not met. The controller 12 may notify the user of items required to satisfy the return conditions by displaying the items on the interface 16 of the management apparatus 10 or the interface 24 of the terminal apparatus 20. The controller 12 may list the items included in the return conditions. The controller 12 may display items so that the user can visually distinguish between items that meet the return conditions and items that do not.

The controller 12 may enable an interface for the return input on the interface 16 of the management apparatus 10 or the interface 24 of the terminal apparatus 20, so that in a case in which the vehicle 50 meets the return conditions, the user can input the operations indicating that the return of the vehicle 50 has been completed. The controller 12 may disable the interface for the return input, so that in a case in which the vehicle 50 does not meet the return conditions, the user cannot input the operations indicating that the return of the vehicle 50 has been completed. The controller 12 may notify the user of the items that must be met to enable the interface for the return input, by displaying the items on the interface 16 of the management apparatus 10 or the interface 24 of the terminal apparatus 20.

The controller 12 may set, as the return conditions for the vehicle 50, conditions that at least part of the return operations have been completed. For example, the controller 12 may set, as one of the return conditions, a condition that the vehicle 50 be parked at the correct return location. The controller 12 may set, as one of the return conditions, a condition that the headlights, the hazard lamps, the interior lights, or the like be turned off. The controller 12 may set, as one of the return conditions, a condition that the interior or exterior of the vehicle 50 be cleaned. The controller 12 may set, as one of the return conditions, a condition that all the user's personal belongings be removed from the vehicle 50. The controller 12 may set, as one of the return conditions, a condition that the in-vehicle devices be turned off. The controller 12 may set, as one of the return conditions, a condition that the engine be stopped in a case in which the vehicle 50 is an engine vehicle. The controller 12 may set, as one of the return conditions, a condition that the main power source be turned off in a case in which the vehicle 50 is an electric vehicle. The controller 12 may set, as one of the return conditions, a condition that the windows of the vehicle 50 be closed and the doors of the vehicle 50 be locked.

The vehicle 50 is returned with the return conditions met, so the management system 1 can manage the states of the vehicle 50 without requiring the worker to inspect the returned vehicle.

The controller 12 may set at least a return condition that the state of charge of the battery of the returned electric vehicle be normal. In other words, the controller 12 may determine that the returned vehicle does not meet the return condition in a case in which the returned vehicle is an electric vehicle and the state of charge of the returned vehicle is not normal.

The controller 12 may determine whether the state of charge of the battery of the returned vehicle is normal, based on the detection result of the power supply to the vehicle 50 by the sensors in the charging facility 60. The controller 12 may determine whether the state of charge of the battery is normal, based on a charging current of the battery detected by the sensors in the charging facility 60 or the sensors in the vehicle 50. The controller 12 may determine whether the state of charge of the battery is normal, based on a resistance value of a charging circuit formed by connecting the charging facility 60 and the vehicle 50. The controller 12 may determine whether the state of charge of the battery is normal based on the location of the vehicle 50 in a case in which the charging facility 60 can charge the battery contactlessly. The controller 12 may determine whether the state of charge of the battery is normal, based on an image that captures the connection state of the power supply cable or the power supply connector to the vehicle 50. The controller 12 may determine whether the state of charge of the battery is normal, based on a detection result of the connection of the power supply cable or the power supply connector to the vehicle 50.

Owing to a normal state of charge of the battery in the returned electric vehicle, a high battery charge rate can be expected when the electric vehicle is rented to the next user. The high battery charge rate allows the next user to use the electric vehicle without worrying about the state of charge. It also reduces anxiety to the user when the user drives the electric vehicle in areas where there are few facilities to charge the electric vehicle. Consequently, the convenience of the user is improved.

### Procedure Example for Management Method

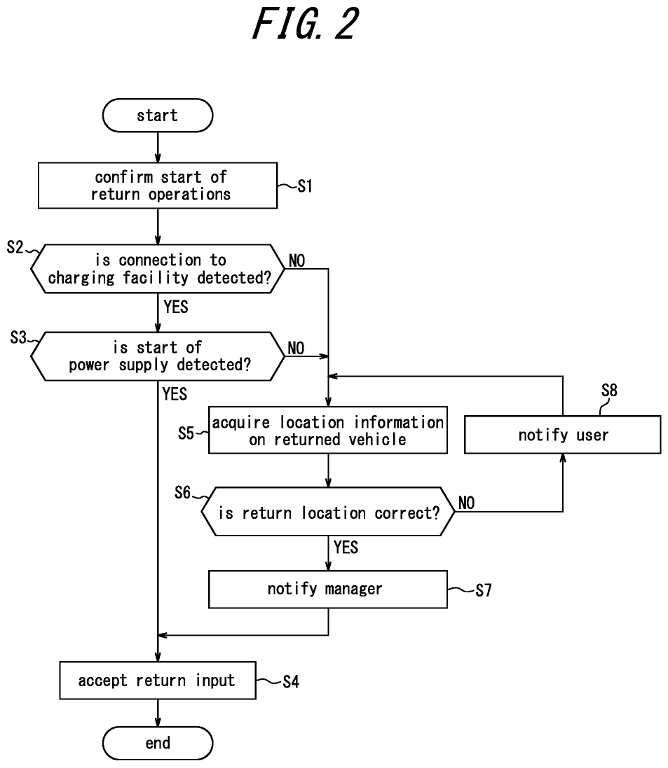

To manage the return of the vehicle 50 in the car sharing service, the controller 12 of the management apparatus 10 may perform a management method including a procedure of a flowchart exemplified by FIG. 2. The management method may be implemented as a management program to be executed by the processor constituting the controller 12. The management program may be stored on a non-transitory computer readable medium.

The controller 12 confirms the start of the return operations for the vehicle 50, based on detection results of the sensors in the vehicle 50 (step S1). The controller 12 determines whether the connection between the returned vehicle and the charging facility 60 is detected, based on detection results of the sensors in the charging facility 60 (step S2). In a case in which the connection between the returned vehicle and the charging facility 60 is detected (step S2: YES), the controller 12 determines whether the start of a power supply is detected based on detection results of the sensors in the charging facility 60 (step S3). In a case in which the start of a power supply is detected (step S3: YES), the controller 12 accepts the return input from the user (step S4). After executing the process of step S4, the controller 12 ends the procedure of the flowchart in FIG. 2.

In a case in which the connection between the returned vehicle and the charging facility 60 is not detected (step S2: NO) or the start of a power supply is not detected (step S3: NO), the controller 12 acquires the location information on the returned vehicle (step S5). The controller 12 determines whether the return location is correct (step S6). In a case in which the return location is correct (step S6: YES), the controller 12 notifies a manager or worker of the car sharing service that the state of charge is not normal despite the return location being correct (step S7). After executing the notification process in step S7, the controller 12 proceeds to the return input accepting process in step S4.

In a case in which the return location is incorrect (step S6: NO), the controller 12 notifies the user by the terminal apparatus 20 or the like that the return location is incorrect (step S8). After executing the notification process in step S8, the controller 12 returns to the process in step S5 and repeats the processes in steps S5 and S6 until the user parks the returned vehicle at a correct location.

In a case in which the connection between the returned vehicle and the charging facility 60 cannot be detected in the determination process of step S2, the controller 12 may repeat the determination process in step S2 until the controller 12 detects the connection. In a case in which the connection cannot be detected in the determination process in step S2, the controller 12 may accept an input from the user to report an abnormality and proceed to the location information acquisition process in step S5. In the determination process in step S2 or S3, the controller 12 may repeat the determination, waiting for an update of the states. In a case in which the connection or the start of a power supply cannot be detected after a predetermined number of determinations, the controller 12 may proceed to the location information acquisition process in step S5. In a case in which the connection or the start of a power supply cannot be detected in the determination process in step S2 or S3, the controller 12 may proceed to the notification process in step S7 without executing the return location determination process in step S6. In the determination process in step S6, the controller 12 may repeat the determination, waiting for an update of the states. In the determination process in step S6, the controller 12 may repeat the determination process in step S6 until the return location is correct. In a case in which it cannot be detected that the return location is correct after a predetermined number of determinations, the controller 12 may proceed to the notification process in step S8.

### Summary

As described above, the management system 1 according to the present embodiment accepts a return in a case in which the vehicle 50 meets the return conditions. In this way, the vehicle 50 is returned in such a state that the user has completed the return operations. As a result, the states of the vehicle 50 can be managed without the need for the worker to inspect the returned vehicle.

### Other Embodiments

Configuration examples of the management system 1 according to other embodiments will be described below.

### Determination Example of Return Conditions

The controller 12 of the management apparatus 10 may determine that the returned vehicle meets the return conditions in a case in which the state of charge of the returned vehicle is not normal and the returned vehicle is an FCEV or a PHEV. In this way, the determination of the state of charge of the electric vehicle that can travel without charging is omitted. As a result, the return operations can be simplified.

After the controller 12 has determined that the return location of the returned vehicle is correct, the controller 12 may determine the state of charge of the returned vehicle. In a case in which the state of charge of the returned vehicle is not normal, the controller 12 may notify the manager or worker of the car sharing service by the interface 16, the terminal apparatus 20, or the like, that the state of charge of the returned vehicle is not normal. In a case in which the state of charge of the returned vehicle is not normal even though the return location is correct, there may be an abnormality in the charging facility 60. The manager or worker of the car sharing service may check the charging facility 60 in response to the notification. In a case in which it is determined that the return location of the returned vehicle is incorrect, the controller 12 may notify the user that the return location of the returned vehicle is incorrect without determining the state of charge of the returned vehicle.

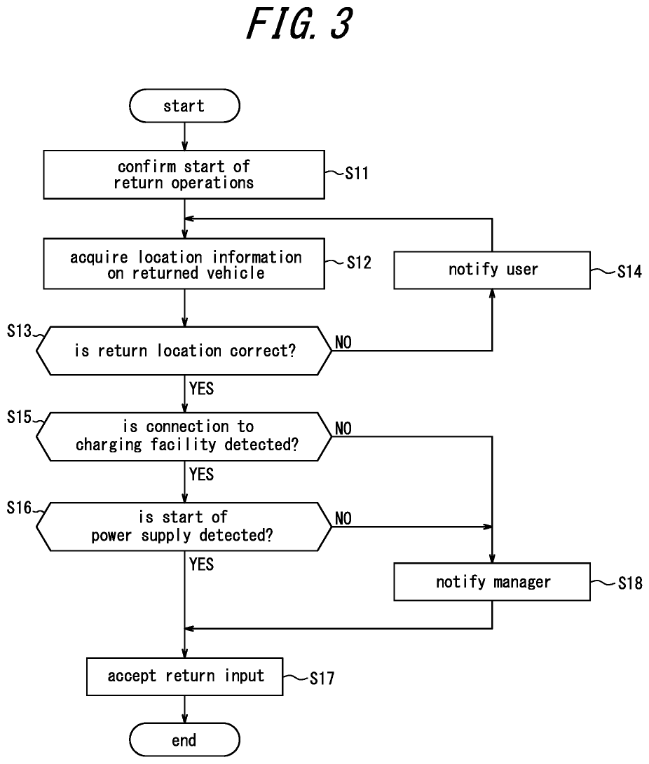

The controller 12 may perform a management method including a procedure of a flowchart exemplified by FIG. 3, as a manner of determining the state of charge after determining the return location.

The controller 12 confirms the start of the return operations for the vehicle 50, based on detection results of the sensors in the vehicle 50 (step S11). The controller 12 acquires the location information on the returned vehicle (step S12). The controller 12 determines whether the return location is correct (step S13). In a case in which the return location is incorrect (step S13: NO), the controller 12 notifies the user by the terminal apparatus 20 or the like that the return location is incorrect (step S14). After executing the notification process in step S14, the controller 12 returns to the process in step S12 and repeats the processes in steps S12 and S13 until the user parks the returned vehicle at the correct location.

In a case in which the return location is correct (step S13: YES), the controller 12 determines whether the connection between the returned vehicle and the charging facility 60 is detected based on detection results of the sensors in the charging facility 60 (step S15). In a case in which the connection between the returned vehicle and the charging facility 60 is detected (step S15: YES), the controller 12 determines whether the start of a power supply is detected, based on detection results of the sensors in the charging facility 60 (step S16). In a case in which the start of a power supply is detected (step S16: YES), the controller 12 accepts the return input from the user (step S17). After executing the process in step S17, the controller 12 ends the procedure of the flowchart in FIG. 3.

In a case in which the connection between the returned vehicle and the charging facility 60 is not detected (step S15: NO) or the start of a power supply is not detected (step S16: NO), the controller 12 notifies the manager or worker of the car sharing service that the state of charge is not normal despite the return location being correct (step S18). After executing the notification process in step S18, the controller 12 proceeds to the return input accepting process in step S17.

In a case in which the return location is incorrect (step S13: NO), the controller 12 notifies the user by the terminal apparatus 20 or the like that the return location is incorrect (step S14). After executing the notification process in step S14, the controller 12 returns to the process in step S12 and repeats the processes in steps S12 and S13 until the user parks the returned vehicle at a correct location.

In the determination process in step S13, the controller 12 may repeat the determination process in step S13 until the return location is correct. In the determination process in step S13, the controller 12 may repeat the determination, waiting for an update of the states. In a case in which it cannot be detected that the return location is correct after a predetermined number of determinations, the controller 12 may proceed to the notification process in step S14. In a case in which the connection between the returned vehicle and the charging facility 60 cannot be detected in the determination process of step S15, the controller 12 may repeat the determination process in step S15 until the controller 12 detects the connection. In a case in which the connection cannot be detected in the determination process in step S15, the controller 12 may accept an input from the user to report an abnormality and proceed to the notification process in step S18. In the determination process in step S15 or S16, the controller 12 may repeat the determination, waiting for an update of the states. In a case in which the connection or the start of a power supply cannot be detected after a predetermined number of determinations, the controller 12 may proceed to the notification process in step S18.

The controller 12 determines the return location first, so unnecessary determination regarding the state of charge is eliminated. As a result, the return operations can be simplified.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

At least some of the functions of the management apparatus 10 of the present disclosure may be realized by the terminal apparatus 20, the ECU of the vehicle 50, or the processor, the dedicated circuit, or the like of the charging facility 60.

1. A management apparatus comprising:
a controller configured to manage one or more vehicles to be rented to users in a car sharing service,
wherein the controller is configured to, in a case in which a vehicle returned by a user does not meet a return condition, notify the user that the return condition is not met when the user inputs an operation for return.

2. The management apparatus according to claim 1, wherein the controller is configured to determine that the returned vehicle does not meet the return condition in a case in which the returned vehicle is an electric vehicle and a state of charge of the returned vehicle is not normal.

3. The management apparatus according to claim 1, wherein the controller is configured to determine that the returned vehicle meets the return condition in a case in which a state of charge of the returned vehicle is not normal and the returned vehicle is a fuel cell electric vehicle (FCEV) or a plug-in hybrid electric vehicle (PHEV).

4. The management apparatus according to claim 1, wherein the controller is configured to:
in a case in which a return location of the returned vehicle is correct, determine a state of charge of the returned vehicle and notify a manager of the car sharing service that the state of charge of the returned vehicle is not normal; and
in a case in which the return location of the returned vehicle is incorrect, notify the user that the return location of the returned vehicle is incorrect without determining the state of charge of the returned vehicle.

5. The management apparatus according to claim 1, wherein the controller is configured to:
in a case in which the returned vehicle meets the return condition, enable an interface for the operation for return; and
in a case in which the returned vehicle does not meet the return condition, disable the interface for the operation for return and display an item that is not met, among items of the return condition.

6. The management apparatus according to claim 2, wherein the controller is configured to:
in a case in which the returned vehicle meets the return condition, enable an interface for the operation for return; and
in a case in which the returned vehicle does not meet the return condition, disable the interface for the operation for return and display an item that is not met, among items of the return condition.

7. The management apparatus according to claim 3, wherein the controller is configured to:
in a case in which the returned vehicle meets the return condition, enable an interface for the operation for return; and
in a case in which the returned vehicle does not meet the return condition, disable the interface for the operation for return and display an item that is not met, among items of the return condition.

8. The management apparatus according to claim 4, wherein the controller is configured to:
in a case in which the returned vehicle meets the return condition, enable an interface for the operation for return; and
in a case in which the returned vehicle does not meet the return condition, disable the interface for the operation for return and display an item that is not met, among items of the return condition.
